(19) United States
(12) Patent Application Publication
(10) Pub. No.: US 2025/0093862 A1
(43) Pub. Date: Mar. 20, 2025

(54) PROCESSING DEVICE, INSPECTION SYSTEM, PROCESSING METHOD, AND COMPUTER PROGRAM PRODUCT

(71) Applicant: KABUSHIKI KAISHA TOSHIBA, Tokyo (JP)

(72) Inventors: Nobukatsu SUGIYAMA, Kawasaki Kanagawa (JP); Junichiro OOGA, Kawasaki Kanagawa (JP); Junji OAKI, Kawasaki Kanagawa (JP)

(73) Assignee: KABUSHIKI KAISHA TOSHIBA, Tokyo (JP)

(21) Appl. No.: 18/761,014

(22) Filed: Jul. 1, 2024

(30) Foreign Application Priority Data
Sep. 15, 2023 (JP) 2023-150346

(51) Int. Cl. G05B 19/425

(52) U.S. Cl. CPC G05B 19/425

(57) ABSTRACT

According to one embodiment, a processing device includes a memory and one or more processors coupled to the memory. The one or more processors are configured to: divide shape data of a surface of an inspection object into a plurality of curved surfaces; calculate a plurality of teaching points indicating positions at which the inspection object is inspected by an inspection device mounted on a movable body; calculate a path between curved surfaces transitioning the plurality of curved surfaces and a path in a curved surface transitioning teaching points within the curved surface of each of the plurality of curved surfaces; and calculate, based on the path between the curved surfaces, the path in the curved surface, and movement performance of the movable body, an orbit of the movable body so that an inspection time of the inspection object becomes shorter.

### CROSS-REFERENCE TO RELATED APPLICATIONS

This application is based upon and claims the benefit of priority from Japanese Patent Application No. 2023-150346, filed on Sep. 15, 2023; the entire contents of which are incorporated herein by reference.

### FIELD

Embodiments described herein relate generally to a processing device, an inspection system, a processing method, and a computer program product.

### BACKGROUND

A device that inspects the surface, inside, etc. of an inspection object to inspect defects such as scratches has been known conventionally. Inspection of an inspection object is performed by attaching an inspection device such as a camera to a movable body such as a robot arm as an alternative means of visual inspection. To inspect all surfaces of the inspection object, it is necessary to appropriately create a path (orbit) of the movable body. The creating of the path is generally taught by a person in many cases to take a lot of man-hours. There has been proposed an inspection system that reduces manual man-hours by performing teaching by a computer based on the shape data of an inspection object.

However, in the conventional art, it is difficult to efficiently find an orbit such that inspection time becomes as short as possible.

### BRIEF DESCRIPTION OF THE DRAWINGS

FIG. 1 is a diagram illustrating an example of a device configuration of an inspection system according to a first embodiment;

FIG. 2 is a diagram illustrating an example of a functional configuration of a processing device according to the first embodiment;

FIG. 3 is a diagram illustrating an example of shape data according to the first embodiment;

FIG. 4 is a diagram explaining a method of forming a curved surface by a set of triangles according to the first embodiment;

FIG. 5A is a diagram illustrating Example 1 of the curved surface according to the first embodiment;

FIG. 5B is a diagram illustrating Example 2 of the curved surface according to the first embodiment;

FIG. 5C is a diagram illustrating Example 3 of the curved surface according to the first embodiment;

FIG. 5D is a diagram illustrating Example 4 of the curved surface according to the first embodiment;

FIG. 5E is a diagram illustrating Example 5 of the curved surface according to the first embodiment;

FIG. 5F is a diagram illustrating Example 6 of the curved surface according to the first embodiment;

FIG. 6 is a diagram illustrating an example of a configuration of an inspection device according to the first embodiment;

FIG. 7 is a flowchart illustrating an example of an overall flow of a processing method according to the first embodiment;

FIG. 8 is a flowchart illustrating an example of a method (detailed flow of Step S1) of dividing shape data into a plurality of curved surfaces according to the first embodiment;

FIG. 9 is a diagram illustrating Example 1 of an orbit created using a conventional rule base;

FIG. 10 is a diagram illustrating Example 2 of the orbit created using the conventional rule base;

FIG. 11 is a diagram illustrating Example 1 of an orbit created by the processing device according to the first embodiment;

FIG. 12 is a diagram illustrating Example 2 of the orbit created by the processing device according to the first embodiment;

FIG. 13 is a diagram illustrating an example of a device configuration of an inspection system according to a second embodiment;

FIG. 14 is a diagram illustrating an example of a device configuration of an inspection system according to a third embodiment;

FIG. 15 is a diagram illustrating an example of a device configuration of an inspection system according to a fourth embodiment; and

FIG. 16 is a diagram illustrating an example of a hardware configuration of the processing device according to the first to fourth embodiments.

### DETAILED DESCRIPTION

In general, according to one embodiment, a processing device includes a memory and one or more processors coupled to the memory. The one or more processors are configured to: divide shape data of a surface of an inspection object into a plurality of curved surfaces; calculate a plurality of teaching points indicating positions at which the inspection object is inspected by an inspection device mounted on a movable body; calculate a path between curved surfaces transitioning the plurality of curved surfaces and a path in a curved surface transitioning teaching points within the curved surface of each of the plurality of curved surfaces; and calculate, based on the path between the curved surfaces, the path in the curved surface, and movement performance of the movable body, an orbit of the movable body so that an inspection time of the inspection object becomes shorter.

Exemplary embodiments of a processing device, an inspection system, a processing method, and a computer program product will be explained below in detail with reference to the accompanying drawings. The present invention is not limited to the following embodiments.

In the case of low-mix high-volume production or high-mix low-volume production, for example, it is considered that sufficient time and computational resource can be prepared until an inspection process is performed after acquiring the shape data of an inspection object. However, in the case of a production system of producing a product on demand, changing an amount of production, or the like, like variable-mix variable-volume production, it is necessary to perform teaching with the limited time and computational resource from the acquisition of the shape data to the completion of inspection.

A problem of passing through all teaching points calculated from shape data to search a path passing through the shortest distance is referred to as a traveling salesman problem. The traveling salesman problem is a difficult problem to solve, which is called NP-hardness in a complexity theory. For that reason, even when using an algorithm or hardware such as quantum annealing and a quantum computer, it is difficult to obtain an optimal solution, an approximate solution, or the like.

In the problem of searching a path described above, assuming that teaching points are set to n points, a calculation amount of the full search is O(n!) and the calculation amount is O(n22n) even if a method that is a relatively efficient algorithm is used, and thus it is known that a calculation amount increases with acceleration if teaching points increase. When there is not sufficient computational resource or time, for example, it is difficult to realize an available inspection system. It is difficult to obtain an optimal solution and thus an algorithm for obtaining an approximate solution has been proposed, but, even in the case of obtaining the approximate solution, reducing teaching points n is the most efficient to suppress the increase in a calculation amount.

Moreover, a difficult problem to solve such as the traveling salesman problem is not solved, and thus even when a path is created with certain rules (e.g., performing inspection from a teaching point at which a value of a specific axis on the coordinate axes is small), a method of efficiently finding a path such that inspection time becomes as short as possible is required.

In the following embodiments, an inspection system that is able to efficiently find a path such that inspection time becomes as short as possible will be described.

### First Embodiment

At first, an example of a device configuration of an inspection system according to the first embodiment will be described.

### Example of Device Configuration

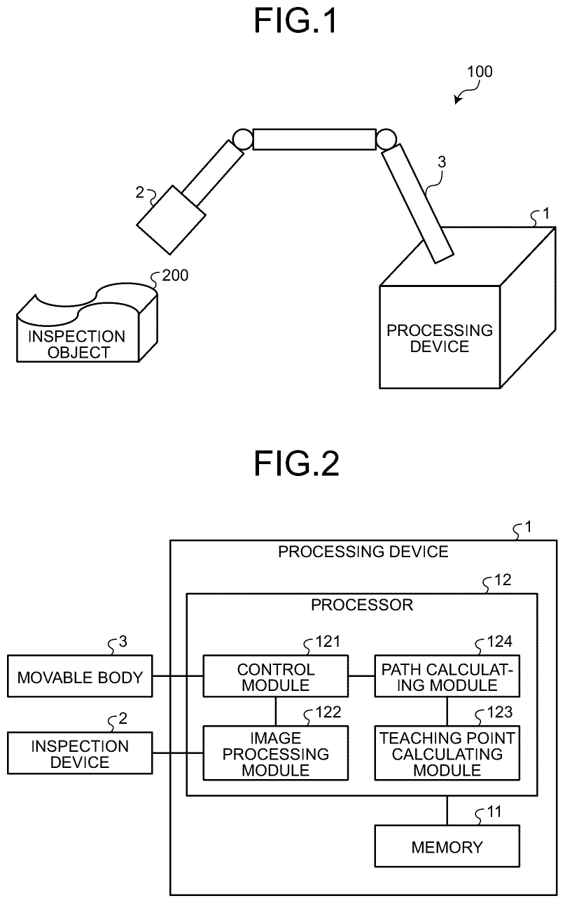

FIG. 1 is a diagram illustrating an example of a device configuration of an inspection system 100 according to the first embodiment. The inspection system 100 according to the first embodiment includes a processing device 1, an inspection device 2, and a movable body 3.

The processing device 1 is a device configured to control operations of the movable body 3 and the inspection device 2.

The inspection device 2 is a device configured to inspect (measure) an inspection object (subject) 200 by using a wave such as light of a camera etc., an ultrasonic wave, a sound wave, and a magnetic field. Note that the inspection device 2 may together include a wave source such as illumination.

The movable body 3 is a mechanism configured to control the three-dimensional position and posture of the inspection device 2. Based on control information calculated by the processing device 1, the movable body 3 controls at least one of the position and posture of the inspection device 2 to inspect the inspection object 200. For example, the movable body 3 is an articulated robot arm. Specifically, the three-dimensional position and posture of the inspection device 2 are changed by an actuator that activates the movable body 3.

### Example of Functional Configuration

FIG. 2 is a diagram illustrating an example of a functional configuration of the processing device 1 according to the first embodiment. The processing device 1 according to the first embodiment includes a memory 11 and a processor 12.

The memory 11 stores therein shape data including positions of a point group indicating the three-dimensional shape of the inspection object 200 and normal vectors of the positions.

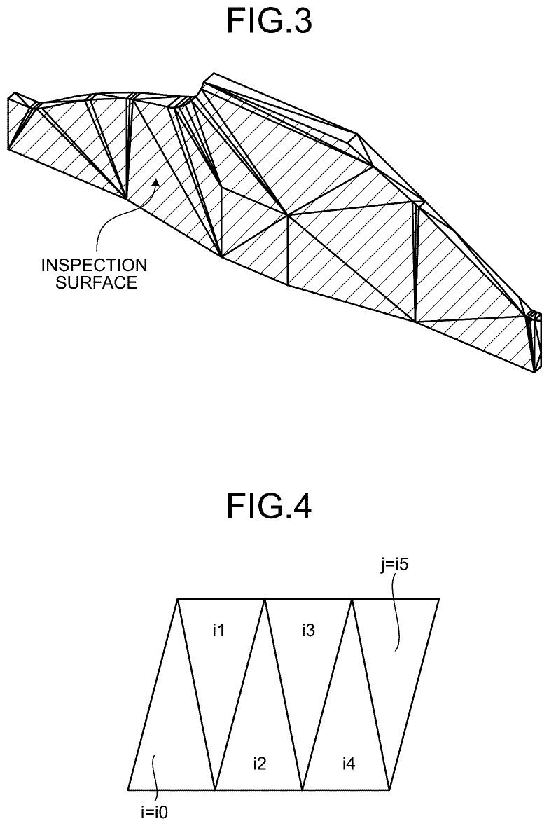

FIG. 3 is a diagram illustrating an example of shape data according to the first embodiment. The shape data is data represented by three vertices of each triangle and outward normal vectors of each triangle, which are represented by the STL format, for example. Each triangle is obtained by performing triangulation on an inspection surface (surface shape) of the inspection object 200.

Returning to FIG. 2, the processor 12 includes a control module 121, an image processing module 122, a teaching point calculating module 123, and a path calculating module 124.

Based on a path (orbit) calculated by the path calculating module 124, the control module 121 calculates control information for controlling at least one of the position and posture of the inspection device 2 mounted on the movable body 3. Based on the control information, the control module 121 controls the inspection device 2 and the movable body 3.

The image processing module 122 processes a surface image of the photographed subject, and determines the presence or absence of a defect or a scratch. Note that the processing device 1 may further include a display module configured to display an image of a defect or a scratch on a display when there is the defect or scratch. Moreover, the processing device 1 may further include a display module configured to display a defect or a scratch on shape data by using information of the movable body.

The teaching point calculating module 123 performs the division of the shape data, and calculates teaching points from the divided shape data. Specifically, a surface (e.g., triangle in case of STL format) designated as the inspection object surface within the shape data is divided into a plurality of curved surfaces. For example, one curved surface is formed by a set of triangles of which normal vectors of adjacent triangles are the same or similar. More specifically, each curved surface is formed by a set of triangles of which an angle (angle by normal vectors of adjacent triangles) by the adjacent triangles is within a certain angle.

FIG. 4 is a diagram explaining a method of forming a curved surface by a set of triangles according to the first embodiment. In the example illustrated in FIG. 4, in a set of six triangles, when a triangle ik and a triangle ik+1 (k=0, . . . , 4) are adjacent and an angle formed by a normal vector of the triangle ik and a normal vector of the triangle ik+1 is not more than x, one curved surface is formed by the six triangles. Note that an angle formed by a triangle i=10 and a triangle j=15 does not need to be not more than x, and adjacent triangles are connected across the adjacent triangles whose angles are not more than x.

In other words, each curved surface is formed by a set of triangles in which a sequence of triangles (i0, i1,i2, . . . , in) in the set exists with reference to a combination (i, j) of arbitrary triangles in the set, and the sequence of triangles satisfies i0=i, in=j, and “i(k) and i(k+1) triangles are adjacent (share one side) and an angle formed by mutual triangles (angle formed by normal vectors) is not more than a certain x”.

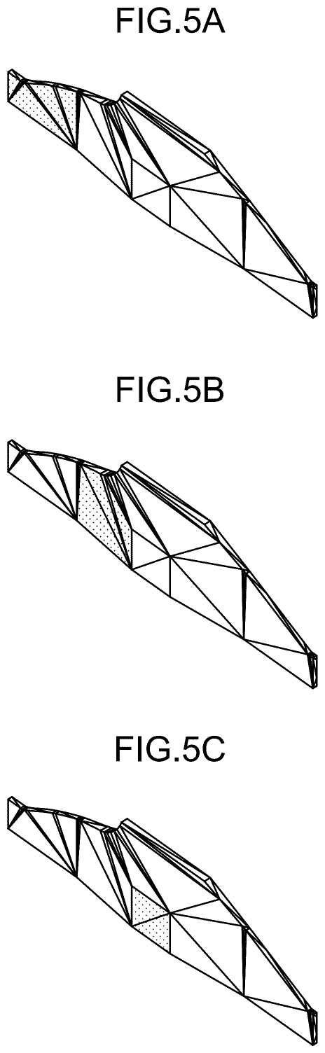

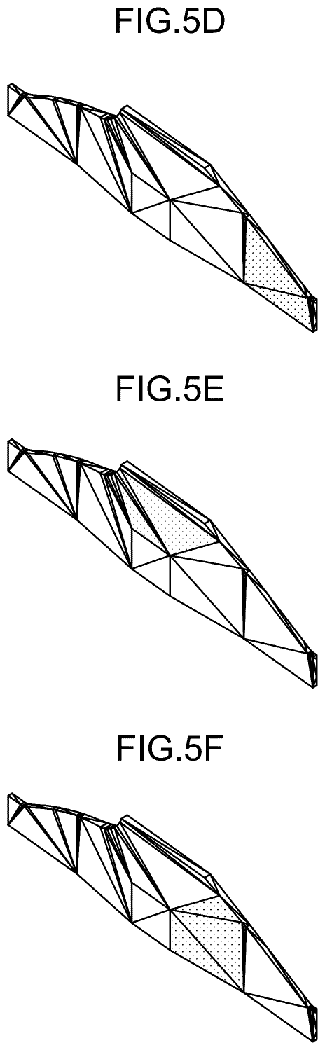

FIGS. 5A to 5F are diagrams illustrating Examples 1 to 6 of the curved surface according to the first embodiment. FIGS. 5A to 5F illustrate cases where the inspection surface of the shape data illustrated in FIG. 3 is classified to six curved surfaces in the method illustrated in FIG. 4. Moreover, points included in each curved surface illustrate an example of teaching points calculated by the teaching point calculating module 123.

Returning to FIG. 2, based on a surface shape of the inspection object 200, a photographable area of the inspection device 2, and a placeable position of the movable body 3, the teaching point calculating module 123 calculates teaching points to be photographed within the shape data from the shape data divided into the plurality of curved surfaces.

The calculation of teaching points is to calculate a position on a surface of the shape for which photographing is performed and a direction (the central axis of the inspection device 2) in which photographing is performed. For example, the surface of the shape data is divided into triangles, and the inspection object 200 is represented by vertices and outward normal vectors of the triangles. In this case, the teaching point calculating module 123 photographs a certain triangle located on a surface on which the subject should be inspected around a teaching point to set teaching points by which all triangles can be photographed. For example, each of the teaching points is calculated by using a centroidal Voronoi tessellation method or a well-known rectangle partition method, or the like.

The path calculating module 124 calculates the orbit of the movable body 3, such that inspection time becomes shorter, through the teaching points calculated from the teaching point calculating module 123. Specifically, from the teaching points calculated by the teaching point calculating module 123, the path calculating module 124 calculates the position and posture of the inspection device 2, the position and posture of the tip of the movable body 3, and the control amount of the movable body 3. The control amount of the movable body 3 is an angle of each joint if the movable body 3 is an articulated robot arm, or is a value corresponding to a movement amount if the movable body 3 is a linear motion mechanism.

Assuming that the number of the teaching points obtained by the teaching point calculating module 123 is “n” and a movement cost from the teaching point i to the teaching point j is “cij”, the path calculating module 124 calculates, through all the teaching points once, a path of the teaching points for which a sum of the movement costs becomes smallest. The cost between the teaching points is obtained by using a distance between the teaching points, the size of a difference between the positions and postures calculated from the teaching points, the size of a difference between the positions and postures of the tip of the movable body 3 calculated from the teaching points, the size of the control amount of the movable body 3 calculated from the teaching points, and the like. Among these costs, some may be used by weighting, or all may be used.

The path whose cost becomes smallest can be calculated by solving the following Expression (1), for example.

$$min \frac{1}{2} {\sum }_{i = 1}^{n} {\sum }_{j = 1}^{n} {\sum }_{k = 1}^{n} {c}_{ij} {n}_{k , i} ( {n}_{k + 1 , j} + {n}_{k - 1 , j} ) \\ s . t . {\sum }_{k = 1}^{n} {n}_{k , i} = 1 ( i = 1 , 2 , … , n ) , {\sum }_{i = 1}^{n} {n}_{k , i} = 1 ( k = 1 , 2 , … , n ) \qquad ( 1 )$$

Herein, “nk,i” is a variable indicating the order of the path in which the variable is 1 if it passes through the teaching point i as the k-th point of the path and the variable is 0 otherwise. The path is obtained if the teaching points i at which nk,i=1 is accomplished are traced in order from k=1. The first expression of a constrained condition is a constraint indicating that a teaching point having nk,i=1 is only one (a teaching point to pass k-th is only one) in each k, and the second expression is a constraint indicating that a teaching points having nk,i=1 is only one (each teaching point is passed through only once) in each i.

In the case of a cyclic circuit (closed circuit), “n0,i=nn,i” and “n1,i=nn+1,i” are satisfied. In the case of an open circuit, “n0,i=0 and “nn+1,i=0” are satisfied.

A problem included in an evaluation function by using the constrained condition as a penalty function is expressed by the following Expression (2).

$$min \frac{1}{2} {\sum }_{i = 1}^{n} {\sum }_{j = 1}^{n} {\sum }_{k = 1}^{n} {c}_{ij} {n}_{k , i} ( {n}_{k + 1 , j} + {n}_{k - 1 , j} ) + {A}_{1} {\sum }_{i}^{n} {( {\sum }_{k}^{n} {n}_{k , i} - 1 )}^{2} + {A}_{2} {\sum }_{k}^{n} {( {\sum }_{i}^{n} {n}_{k , i} - 1 )}^{2} \qquad ( 2 )$$

Herein, A1 and A2 are parameters indicating weight.

Assuming that a vector indicating the position of the inspection device at the teaching point i is pi, a central axis vector is ai, a vector indicating the position of the tip of the movable body is yi, a central axis vector bi, and a vector indicating the control amount of the movable body is qi, a cost function is expressed by the following Expression (3) etc., for example.

$${c}_{ij} = {z}_{1} {‖ {p}_{i} - {p}_{j} ‖}_{2} + {z}_{2} {‖ {a}_{i} - {a}_{j} ‖}_{2} + {z}_{3} {‖ {y}_{i} - {y}_{j} ‖}_{2} + {z}_{4} {‖ {b}_{i} - {b}_{j} ‖}_{2} + {z}_{5} {‖ {q}_{i} - {q}_{j} ‖}_{2} \qquad ( 3 )$$

Herein, z1 to z5 are parameters indicating weight and are a real number not less than 0. A cost can be calculated by weighting or ignoring a plurality of vector quantities by setting the weight.

Because it is known that the present problem cannot be solved with a polynomial time, local optimization, an approximate solution, etc. may be used even if it is not an optimal solution. A solution method can be solved by a heuristic method such as combination optimization by conversion to the ising model H (the following Expression (4)), GA (Genetic Algorithm), and SA (Simulated Annealing).

$$H = {\sum }_{i = 1}^{N} {\sum }_{j = 1}^{N} {J}_{ij} {s}_{i} {s}_{j} - {\sum }_{i}^{N} {h}_{i} {s}_{i} \qquad ( 4 )$$

Herein, “H” is the energy of the ising model. Moreover, “s” is a spin, and “N” is the number of spins. Moreover, “J” and “h” are well-known parameters.

### Example of Configuration of Inspection Device

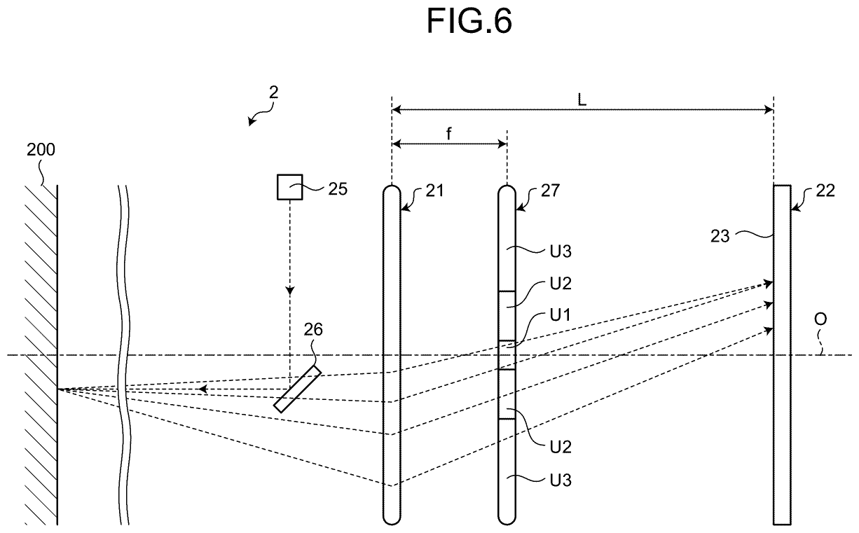

FIG. 6 is a diagram illustrating an example of a configuration of the inspection device 2 according to the first embodiment. As illustrated in FIG. 6, the inspection device 2 is an optical device that includes an imaging optical system 21, and performs photographing by forming an image by the imaging optical system 21. The imaging optical system 21 has an optical axis O, and is made of one or more lenses, for example. In the inspection device 2, an optical axis direction along the optical axis O of the imaging optical system is defined.

The inspection device 2 includes an imaging element 22. In inspecting the inspection object 200, the imaging element 22 is arranged around the imaging optical system 21 in the optical axis direction on the opposite side to a side on which the inspection object 200 is located. The imaging element 22 forms an imaging surface 23 of the imaging optical system 21, and an image etc. of the surface of the inspection object 200 are formed by the imaging optical system 21 on the imaging surface 23 of the imaging element 22. Moreover, compared with a focus position of the imaging optical system 21, the imaging element 22 is arranged apart from the imaging optical system 21, and a distance L from the imaging optical system 21 to the imaging element 22 is larger than a focal length f of the imaging optical system 21.

The imaging optical system 21 causes light from the inspection object 200 to be incident on the imaging element 22. The imaging optical system 21 may be a lens, a group lens, a light guide lens, a gradient index lens, a reflecting mirror, or the like, and is sufficient if it images light. Therefore, in inspecting the inspection object 200, light is incident on the imaging surface 23 of the imaging element 22 through the imaging optical system 21 from the inspection object 200. The imaging element 22 captures the light incident on the imaging surface 23. Thus, the imaging element 22 generates an electrical signal indicating information on the formed image to photograph the inspection object 200.

In the example of FIG. 6, the inspection device 2 includes a light source 25 and a mirror 26, and light from the light source 25 is incident on the inspection object 200 via the mirror 26. In this regard, however, the size of the mirror 26 has no particular limitation and FIG. 6 is just an example. Then, light reflected by the inspection object 200 is incident on the imaging element 22 by the imaging optical system 21. Moreover, in one example, the light from the light source may be caused to be incident on the inspection object 200 by using an illumination optical system made of one or more lenses, and the light transmitted through the inspection object 200 may be caused to be incident on the imaging element by the imaging optical system. Incidence onto the imaging element of the light transmitted through the inspection object 200 is realized similarly to that of Japanese Laid-Open Patent Application 2019-124542, for example.

In the inspection device 2, a color filter 27 is arranged between the imaging optical system 21 and the imaging element 22 in the optical axis direction. Therefore, the color filter 27 is arranged on an optical path of light incident on the imaging element 22 through the imaging optical system 21. The color filter 27 is arranged without deviating or without substantially deviating from the focus position of the imaging optical system 21 in the optical axis direction, and the distance from the imaging optical system 21 to the color filter 27 is the same or substantially the same size as the focal length f of the imaging optical system 21.

The color filter 27 includes one or more wavelength selection areas, and includes three wavelength selection areas U1 to U3 in the example of FIG. 6. In the example of FIG. 6, the color filter 27 is formed in a rotationally symmetrical or substantially rotationally symmetrical manner around the optical axis O. Then, in the color filter 27, the wavelength selection area (first wavelength selection area) U1 is formed in a central area through which the optical axis O passes, the wavelength selection area (second wavelength selection area) U2 is formed adjacent to the outer circumferential side of the wavelength selection area U1, and the wavelength selection area (third wavelength selection area) U3 is formed adjacent to the outer circumferential side of the wavelength selection area U2. In the example of FIG. 6, the outermost circumference of the color filter 27 is formed by the wavelength selection area U3.

The wavelength selection area U1 transmits only light in the first wavelength range (predetermined wavelength range). The wavelength selection area U2 transmits light in the second wavelength range different from the first wavelength range. Moreover, the wavelength selection area U3 transmits light in the third wavelength range different from the first wavelength range and the second wavelength range. In one example, the first wavelength range coincides with or substantially coincides with the wavelength range of red light, the second wavelength range coincides with or substantially coincides with the wavelength range of green light, and the third wavelength range coincides with or substantially coincides with the wavelength range of blue light.

The light transmitted through each of the wavelength selection areas U1 to U3 of the color filter 27 is incident on the imaging element 22. Moreover, an electrical signal generated by the imaging element 22 indicates, as information on the formed image, information on light intensity incident onto the imaging element 22 from each of the wavelength selection areas U1 to U3, that is, information on incident intensity onto the imaging element 22 for light of each of the first wavelength range to the third wavelength range. Therefore, in the present embodiment, the electrical signal generated by the imaging element 22 indicates information on incident intensity onto the imaging element 22 for light of each of one or more wavelength ranges.

In the configuration of causing light transmitted through the inspection object 200 to be incident on the imaging element, a first color filter may be provided between the inspection object 200 and the imaging element 22 as described above, and a second color filter may be provided between the light source and the inspection object 200. In this case, the first color filter and the second color filter are arranged similarly to that of Japanese Laid-Open Patent Application 2019-124542, and wavelength selection areas are respectively formed in the two color filters similarly to that of Japanese Laid-Open Patent Application 2019-124542. In one example, a wavelength selection area is formed at least in the central area in each of the two color filters. In a state where light that can pass through the central area of the first color filter cannot pass through the central area of the second color filter, and light that can pass through the central area of the second color filter cannot pass through the central area of the first color filter, a wavelength of light passing through each of the wavelength selection areas of the two color filters is defined.

As described above, in the present embodiment, by providing the color filter 27 or the above first color filter, for example, a color filter is arranged on the optical path of light to be incident to the imaging element 22 from the inspection object 200. Moreover, by providing the above second color filter, for example, a color filter may be provided on the optical path of light to be incident to the inspection object 200 from the light source. Then, in the present embodiment, a wavelength selection area transmitting only light within the predetermined wavelength range is formed in each of the color filters. Moreover, a plurality of wavelength selection areas may be formed in one or more of the color filters. In this case, the plurality of wavelength selection areas have mutually different wavelength ranges of light to be transmitted. In this regard, however, the plurality of wavelength ranges may have a portion to overlap each other. Moreover, the one or more wavelength selection areas as well as at least one of an area transmitting light of all wavelengths and an area not transmitting light of all wavelengths may be formed in one or more of the color filters.

As illustrated in FIG. 6 described above, for example, the inspection device 2 according to the first embodiment includes the imaging optical system 21, the imaging element 22, and the color filter 27. The imaging element 22 forms thereon the imaging surface 23 of the imaging optical system 21, and captures the light incident through the imaging optical system 21. The color filter 27 includes the wavelength selection areas U1 to U3 each transmitting the light within the predetermined wavelength range and is arranged on the optical path of the light to be incident on the imaging element 22 through the imaging optical system 21 to cause the light within the predetermined wavelength range transmitted through the wavelength selection areas U1 to U3 to be incident on the imaging element 22.

### Example of Processing Method

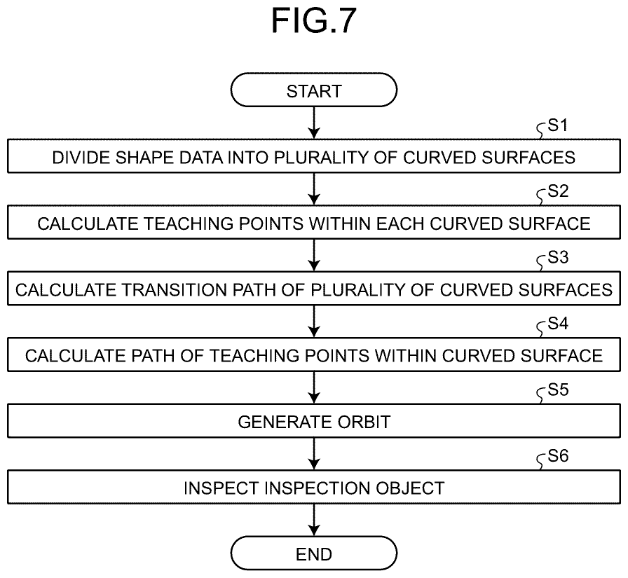

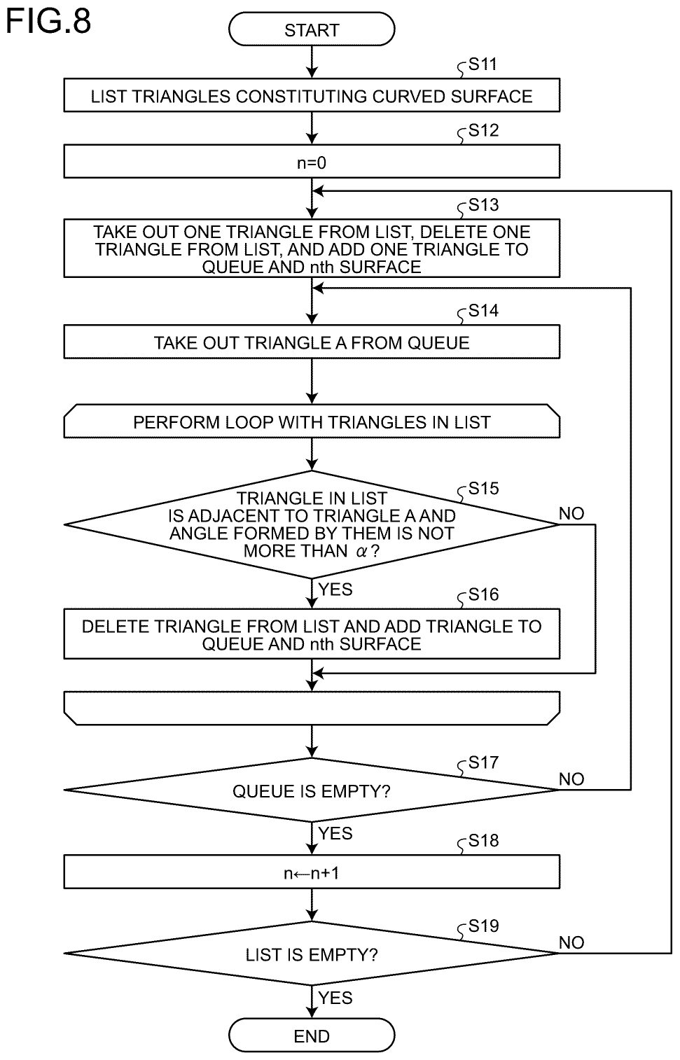

FIG. 7 is a flowchart illustrating an example of a processing method according to the first embodiment. At first, the teaching point calculating module 123 divides shape data into a plurality of curved surfaces (Step S1). The detailed flow of Step S1 will be described later with reference to FIG. 8.

Next, the teaching point calculating module 123 calculates teaching points within each curved surface (Step S2). For example, the teaching point calculating module 123 calculates the teaching points within each curved surface at 2 mm intervals.

Next, the path calculating module 124 calculates a transition path of the plurality of curved surfaces obtained in Step S1 (Step S3). Next, the path calculating module 124 calculates a path of the teaching points within the curved surface (Step S4).

Next, based on the path between the curved surfaces (path indicating order of transitioning curved surfaces) transitioning the plurality of curved surfaces calculated in Step S3, the path in the curved surface transitioning the teaching points within the curved surface calculated in Step S4, and the movement performance of the movable body 3, the path calculating module 124 generates an orbit so that the inspection time of the inspection object 200 becomes shorter (Step S5).

Next, based on the orbit generated in Step S5, the control module 121 controls the inspection device 2 and the movable body 3 to inspect the inspection object 200 (Step S6).

FIG. 8 is a flowchart illustrating an example of the method (detailed flow of Step S1) of dividing the shape data into the plurality of curved surfaces according to the first embodiment. At first, the teaching point calculating module 123 lists triangles constituting the curved surface (Step S11). Next, the teaching point calculating module 123 initializes a variable n of recognizing the curved surface to 0 (Step S12).

Next, the teaching point calculating module 123 takes out one triangle from the list created in Step S11, deletes the one triangle from the list, adds the triangle to a queue, and adds the triangle to the nth surface (Step S13).

Next, the teaching point calculating module 123 takes out an unprocessed triangle A from the queue (Step S14). Next, the teaching point calculating module 123 determines whether a triangle included in the list is adjacent to the triangle A and an angle formed by the triangle and the triangle A is not more than α (Step S15). The angle formed by the triangle in the list and the triangle A is calculated by an angle formed by a normal vector of the triangle in the list and a normal vector of the triangle A.

When the triangle included in the list is adjacent to the triangle A and the angle formed by the triangle and the triangle A is not more than α (Step S15: Yes), the teaching point calculating module 123 deletes this triangle from the list, adds this triangle to the queue, and adds this triangle to the nth surface (Step S16).

The teaching point calculating module 123 performs the determination of Step S15 on all triangles included in the list, and repeatedly performs a series of processes of executing Step S16 when Step S15 is Yes.

Next, the teaching point calculating module 123 determines whether the queue is empty (Step S17). When the queue is not empty (Step S17: No), the process returns to Step S14. When the queue is empty (Step S17: Yes), the teaching point calculating module 123 increments the variable n of recognizing the curved surface (Step S18).

Next, the teaching point calculating module 123 determines whether the list is empty (Step S19). When the list is not empty (Step S19: No), the process returns to Step S13. When the list is empty (Step S19: Yes), the process is terminated.

### Effect of First Embodiment

As described above, in the inspection system 100 according to the first embodiment, the inspection device 2 inspects the inspection object 200. The movable body 3 controls at least one of the position and posture of the inspection device 2. Moreover, the processing device 1 includes the processor 12 that divides the shape data of the surface of the inspection object 200 into the plurality of curved surfaces, calculates the plurality of teaching points indicating positions at which the inspection object 200 is inspected by the inspection device 2, calculates the path between the curved surfaces transitioning the plurality of curved surfaces and the path in the curved surface transitioning the teaching points within each curved surface of the plurality of curved surfaces, and calculates, based on the path between the curved surfaces and the path in the curved surface, and the movement performance of the movable body 3, the orbit of the movable body 3 so that the inspection time of the inspection object becomes shorter.

Thus, according to the inspection system 100 of the first embodiment, it is possible to efficiently find the orbit that shortens inspection time as much as possible. Because the number of teaching points in one problem becomes small when calculating the path such that the movement cost handled by the path calculating module becomes smallest by dividing the path between the curved surfaces and the path in the curved surface, a path searching time can be shortened and an inspection time can be shortened by reducing the number of teaching points n in one path searching problem.

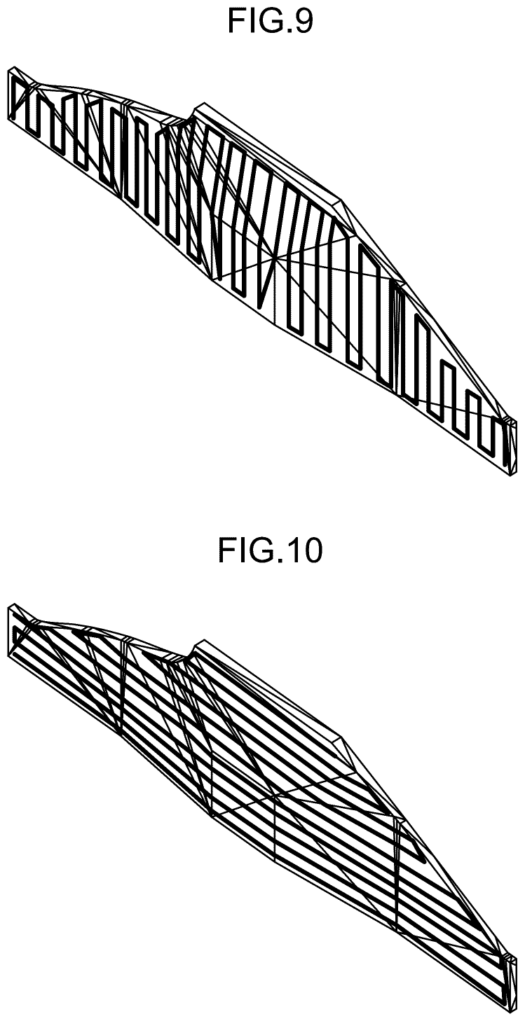

FIG. 9 is a diagram illustrating Example 1 of an orbit created using the conventional rule base. Example 1 of FIG. 9 is an example of an orbit that gradually moves in the lateral direction while moving in the longitudinal direction assuming that the inspection surface of FIG. 3 is an inspection target. The operating time of this orbit is 28 seconds.

FIG. 10 is a diagram illustrating Example 2 of the orbit created using the conventional rule base. Example 2 of FIG. 9 is an example of an orbit that gradually moves in the longitudinal direction while moving in the lateral direction assuming that the inspection surface of FIG. 3 is an inspection target. The operating time of this orbit is 37 seconds.

On the other hand, FIG. 11 is a diagram illustrating Example 1 of an orbit created by the processing device 1 according to the first embodiment. Like FIGS. 5A to 5F described above, FIG. 11 is an example of an orbit that mainly moves in the longitudinal direction within the range divided into six curved surfaces. The operating time of the orbit of FIG. 11 is 20 seconds, and the operating time of the orbit is shortened by eight seconds in comparison with the example of FIG. 9.

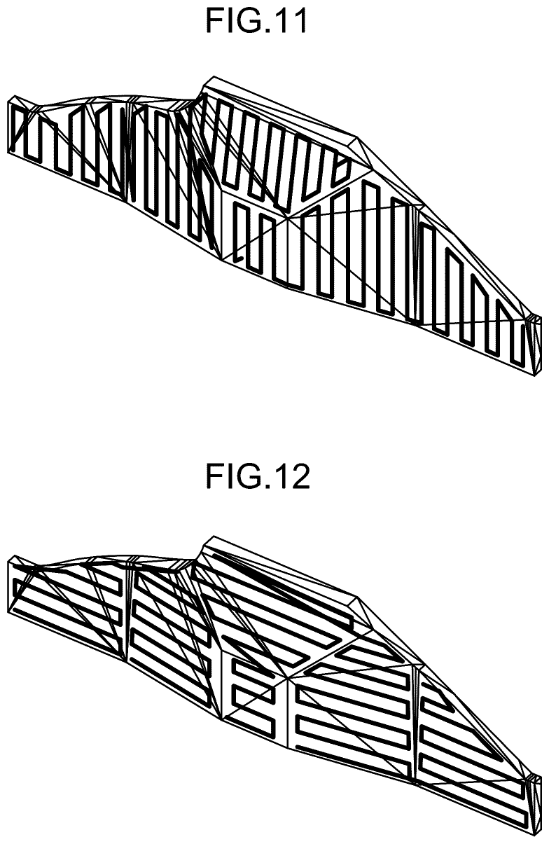

FIG. 12 is a diagram illustrating Example 2 of the orbit created by the processing device 1 according to the first embodiment. Like FIGS. 5A to 5F described above, FIG. 12 is an example of the orbit that mainly moves in the lateral direction within the range divided into six curved surfaces. The operating time of the orbit of FIG. 12 is 15 seconds, and the operating time of the orbit is shortened by 22 seconds in comparison with the example of FIG. 9. The operating time of the movable body 3 in FIGS. 5A to 5F is calculated assuming a six-axis articulated robot having a sufficient size with reference to the inspection object.

The movement performance of the movable body 3 includes the horizontal movement speed of the curved surface and the vertical movement speed of the curved surface, for example. For example, when the vertical movement speed of the curved surface is faster than the horizontal movement speed of the curved surface, because the orbit of FIG. 11 has a vertical movement amount larger than that of the orbit of FIG. 12, the orbit of FIG. 11 is more advantageous than the orbit of FIG. 12. Conversely, when the horizontal movement speed of the curved surface is faster than the vertical movement speed of the curved surface, because the orbit of FIG. 12 has a horizontal movement amount larger than that of the orbit of FIG. 11, the orbit of FIG. 12 is more advantageous than the orbit of FIG. 11.

For example, the speed is a parallel movement speed and a posture change speed of the tip. For example, when the posture change speed is faster than the parallel movement speed, because the movement in the curved surface is a parallel movement and the movement between the curved surfaces is a posture change movement, the orbits of FIGS. 11 and 12 having the movement between the curved surfaces smaller than FIGS. 9 and 10 are more advantageous. Furthermore, when a linear movement speed is faster than a curve movement speed even in the parallel movement, because the orbit of the FIG. 12 has the number of curve movements smaller than that of the orbit of FIG. 11, the orbit of FIG. 12 is more advantageous than the orbit of FIG. 11.

Compared to performing the path search, the path calculation time of the path calculation by the rule base is negligibly small, and the size of the calculation time by the curved surface division is also small. Therefore, even when performing the path search, or even when determining the path based on the rule base, the inspection time can be shortened. The inspection time includes an orbit calculation time until the orbit of the movable body 3 is calculated and an operating time of the movable body 3 when inspecting the inspection object 200.

Note that the teaching point calculating module 123 may divide the shape data of the surface of the inspection object 200 into the plurality of curved surfaces by using polygonal division such as quadrangle instead of the triangulation described above. In other words, the teaching point calculating module 123 may apply the polygonal division to the shape data of the surface of the inspection object 200, namely, divide the shape data of the surface of the inspection object 200 into a set of polygons in which an angle between normal vectors of adjacent polygons is not more than a threshold to divide the shape data into the plurality of curved surfaces.

Moreover, the teaching point calculating module 123 may divide the shape data of the surface of the inspection object 200 into the plurality of curved surfaces in a method other than the polygonal division. For example, the teaching point calculating module 123 may divide the shape data of the surface of the inspection object 200 into areas in which a range of a curvature of the surface shape is not more than a threshold to divide the shape data into the plurality of curved surfaces.

### Second Embodiment

Next, a second embodiment will be described. In the explanation for the second embodiment, the same explanation as the first embodiment is omitted, and a difference from the first embodiment will be described. In the second embodiment, for example, a case where the inspection object 200 produced in a variable-mix variable-volume production manner is inspected under a situation of being conveyed by the belt conveyor type will be described.

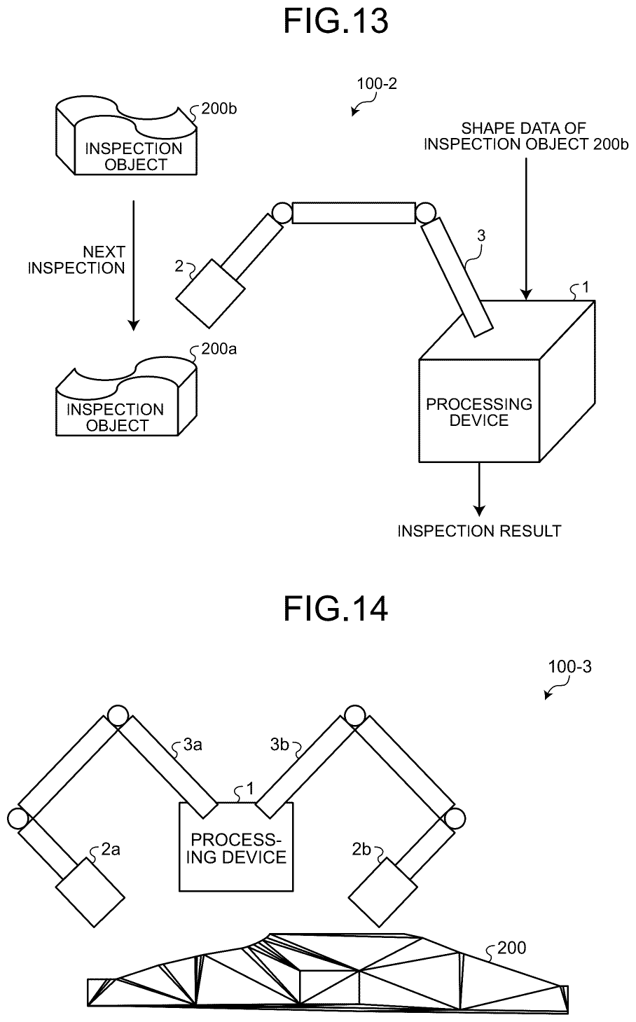

FIG. 13 is a diagram illustrating an example of a device configuration of an inspection system 100-2 according to the second embodiment. FIG. 13 illustrates an example of the system configuration in which a plurality of the inspection objects 200 including inspection objects 200a and 200b are inspected on demand.

The processor 12 according to the second embodiment accepts shape data of the plurality of inspection objects 200 in order and processes the shape data of the plurality of inspection objects 200 in order to calculate control information of the movable body 3.

Moreover, based on the control information, the movable body 3 according to the second embodiment controls at least one of the position and posture of the inspection device 2 to inspect the plurality of inspection objects 200 in order.

### Third Embodiment

Next, a third embodiment will be described. In the explanation for the third embodiment, the same explanation as the first embodiment is omitted, and a difference from the first embodiment will be described. In the third embodiment, a case where a plurality of the inspection devices 2 are provided will be described.

FIG. 14 is a diagram illustrating an example of a device configuration of an inspection system 100-3 according to the third embodiment. The example illustrated in FIG. 14 illustrates a case where an inspection device 2a is mounted on a movable body 3a and an inspection device 2b is mounted on a movable body 3b.

The processor 12 according to the third embodiment assigns inspections of one or more curved surfaces included in a plurality of curved surfaces to the respective inspection devices 2a and 2b. Then, the inspection devices 2a and 2b can respectively inspect the one or more curved surfaces assigned by the processor 12 to promote the efficiency of inspection of the inspection object 200.

### Fourth Embodiment

Next, a fourth embodiment will be described. In the explanation for the fourth embodiment, the same explanation as the first embodiment is omitted, and a difference from the first embodiment will be described. In the fourth embodiment, a case where a shaft mechanism that moves the position of the movable body 3 on the axis is further included will be described.

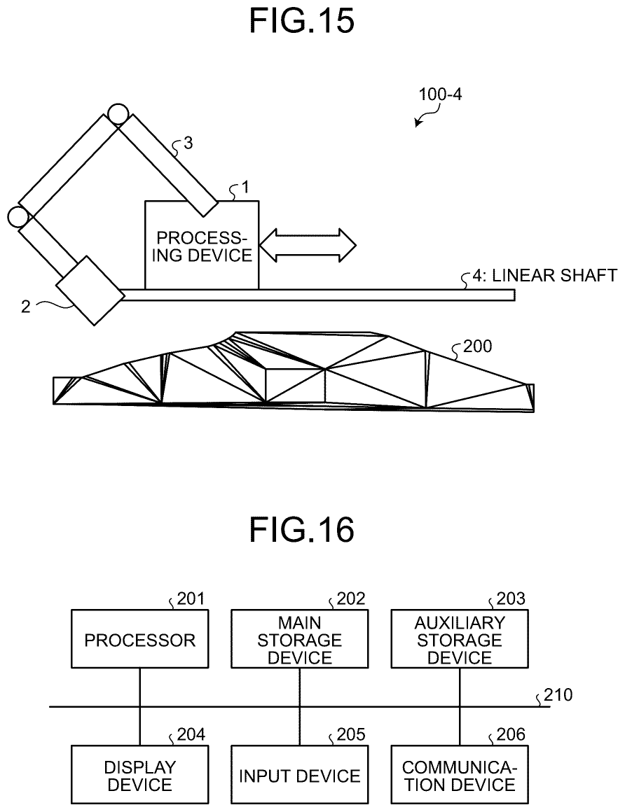

FIG. 15 is a diagram illustrating an example of a device configuration of an inspection system 100-4 according to the fourth embodiment. FIG. 15 illustrates a case where a linear shaft 4 (e.g., rail etc.) is included as an example of the shaft mechanism.

Further based on the movement performance of the linear shaft 4, the processor 12 according to the fourth embodiment calculates an orbit of the movable body 3. For example, when the movement speed on the axis in the linear shaft 4 is slower than the movement speed of the movable body 3, the processor 12 assigns inspections of the one or more curved surfaces included in the plurality of curved surfaces to one or more inspection positions on the axis to calculate an orbit of the movable body 3 so that at least one of the number of movements and the movement distance on the axis becomes smaller.

Note that the processor 12 may further divide a curved surface having an area above a certain level into a plurality of divided curved surfaces to reduce the number of movements of the linear shaft 4. For example, a curved surface of which the axial length of the linear shaft 4 is above a certain level may be divided into two divided curved surfaces so that the axial length of the divided curved surface is the half. In this case, by inspecting a corresponding divided curved surface at an inspection position of each divided curved surface, at least one of the number of movements and the movement distance on the axis can be reduced more.

Finally, an example of a hardware configuration of the processing device 1 according to the first to fourth embodiments will be described.

### Example of Hardware Configuration

FIG. 16 is a diagram illustrating an example of a hardware configuration of the processing device 1 according to the first to fourth embodiments. The processing device 1 according to the first to fourth embodiments includes a processor 201, a main storage device 202, an auxiliary storage device 203, a display device 204, an input device 205, and a communication device 206. The processor 201, the main storage device 202, the auxiliary storage device 203, the display device 204, the input device 205, and the communication device 206 are connected via a bus 210.

Note that the processing device 1 may not include some of the devices of the above configuration. For example, when the processing device 1 can use an input function and a display function of an external device, the processing device 1 may not include the display device 204 and the input device 205.

The processor 201 executes a program read into the main storage device 202 from the auxiliary storage device 203. The main storage device 202 is a memory such as ROM and RAM. The auxiliary storage device 203 is a hard disk drive (HDD), a memory card, or the like.

The display device 204 is a liquid crystal display etc., for example. The input device 205 is an interface for operating the processing device 1. Note that the display device 204 and the input device 205 may be realized by a touch panel etc. having a display function and an input function. The communication device 206 is an interface for communicating with other devices.

For example, the program executed by the processing device 1 is recorded in a computer-readable storage medium such as a memory card, a hard disk, CD-RW, CD-ROM, CD-R, DVD-RAM, and DVD-R in an installable format or executable format file, and is provided as a computer program product.

Moreover, for example, the program executed by the processing device 1 may be configured to be provided by being stored on a computer connected to a network such as the Internet and being downloaded by way of the network.

Moreover, for example, the program executed by the processing device 1 may be configured to be provided by way of a network such as the Internet without downloading the program. Specifically, for example, the program may be configured to be processed by an ASP (application service provider) type cloud service.

Moreover, for example, the program of the processing device 1 may be configured to be provided by being previously incorporated into ROM etc.

The program executed by the processing device 1 has a module configuration that includes a function that can also be executed by the program, among of the functions of the functional configuration described above. From the viewpoint of actual hardware, for each function, the processor 201 reads a program from a storage medium and executes the program, and thus each functional block is loaded on the main storage device 202. In other words, each the functional block is generated on the main storage device 202.

Note that some or all of the functions described above may be realized by hardware such as an integrated circuit (IC) without realizing the some or all of the functions by software.

Moreover, the functions may be realized by using a plurality of the processors 201. In that case, each of the processors 201 may realize one of the functions, or may realize two or more of the functions.

Configuration examples of the embodiments are described below.

(Configuration example 1) A processing device includes a memory and one or more processors coupled to the memory and configured to: divide shape data of a surface of an inspection object into a plurality of curved surfaces; calculate a plurality of teaching points indicating positions at which the inspection object is inspected by an inspection device mounted on a movable body; calculate a path between curved surfaces transitioning the plurality of curved surfaces and a path in a curved surface transitioning teaching points within the curved surface of each of the plurality of curved surfaces; and calculate, based on the path between the curved surfaces, the path in the curved surface, and movement performance of the movable body, an orbit of the movable body so that an inspection time of the inspection object becomes shorter.

(Configuration example 2) In the device according to Configuration example 1, the movement performance of the movable body includes at least one of a horizontal movement speed of the curved surface, a vertical movement speed of the curved surface, a parallel movement speed of the curved surface, and a curve movement speed of the curved surface, and the inspection time includes an orbit calculation time until the orbit of the movable body is calculated and an operating time of the movable body when the inspection object is inspected.

(Configuration example 3) In the device according to Configuration example 1 or 2, the one or more processors are configured to divide the shape data of the surface of the inspection object into areas in which a range of a curvature of the surface shape is not more than a threshold to divide the shape data into the plurality of curved surfaces.

(Configuration example 4) In the device according to any one of Configuration examples 1 to 3, the one or more processors are configured to: perform polygonal division on the shape data of the surface of the inspection object; and divide the shape data of the surface of the inspection object into a set of polygons in which an angle between normal vectors of adjacent polygons is not more than a threshold to divide the shape data into the plurality of curved surfaces.

(Configuration example 5) In the device according to any one of Configuration examples 1 to 4, the one or more processors are configured to calculate, based on the orbit of the movable body, control information controlling at least one of a position and a posture of the inspection device mounted on the movable body.

(Configuration example 6) An inspection system includes: an inspection device configured to inspect an inspection object; a movable body configured to control at least one of a position and a posture of the inspection device; and a processing device. The processing device includes: a memory; and one or more processors coupled to the memory and configured to: divide shape data of a surface of the inspection object into a plurality of curved surfaces; calculate a plurality of teaching points indicating positions at which the inspection object is inspected by the inspection device; calculate a path between curved surfaces transitioning the plurality of curved surfaces and a path in a curved surface transitioning teaching points within the curved surface of each of the plurality of curved surfaces; and calculate, based on the path between the curved surfaces, the path in the curved surface, and movement performance of the movable body, an orbit of the movable body so that an inspection time of the inspection object becomes shorter.

(Configuration example 7) In the system according to Configuration example 6, the inspection device includes: an imaging optical system; an imaging element configured to form an imaging surface of the imaging optical system, the imaging element being configured to capture light incident through the imaging optical system; and a color filter that includes a wavelength selection area transmitting light within a predetermined wavelength range and is arranged on an optical path of the light to be incident on the imaging element through the imaging optical system, the color filter causing the light within the predetermined wavelength range transmitted through the wavelength selection area to be incident on the imaging element.

(Configuration example 8) In the system according to Configuration example 6 or 7, the one or more processors are configured to calculate, based on the orbit of the movable body, control information controlling at least one of the position and the posture of the inspection device, and the movable body controls, based on the control information, at least one of the position and the posture of the inspection device to inspect the inspection object.

(Configuration example 9) In the system according to Configuration example 8, the inspection object includes a plurality of inspection objects, the one or more processors are configured to accept shape data of the plurality of inspection objects in order and process the shape data of the plurality of inspection objects in order to calculate control information of the movable body, and the movable body controls, based on the control information, at least one of the position and the posture of the inspection device to inspect the plurality of inspection objects in order.

(Configuration example 10) In the system according to any one of Configuration examples 6 to 9, the inspection device includes a plurality of inspection devices and the movable body includes a plurality of movable bodies, the one or more processors are configured to assign inspections of one or more curved surfaces included in the plurality of curved surfaces to the respective inspection devices, and the inspection devices respectively inspect the one or more curved surfaces assigned by the one or more processors to inspect the inspection object.

(Configuration example 11) In the system according to any one of Configuration examples 6 to 10, the system further includes a shaft mechanism configured to move a position of the movable body on an axis, and the one or more processors are configured to assign, when a movement speed on the axis by the shaft mechanism is slower than a movement speed of the movable body, inspections of one or more curved surfaces included in the plurality of curved surfaces to one or more inspection positions on the axis to calculate the orbit of the movable body so that at least one of a number of movements and a movement distance on the axis becomes smaller.

(Configuration example 12) A processing method includes: dividing, by a processing device, shape data of a surface of an inspection object into a plurality of curved surfaces; calculating, by the processing device, a plurality of teaching points indicating positions at which the inspection object is inspected by an inspection device mounted on a movable body; calculating, by the processing device, a path between curved surfaces transitioning the plurality of curved surfaces and a path in a curved surface transitioning teaching points within the curved surface of each of the plurality of curved surfaces; and calculating, by the processing device, based on the path between the curved surfaces, the path in the curved surface, and movement performance of the movable body, an orbit of the movable body so that an inspection time of the inspection object becomes shorter.

(Configuration example 13) A computer program product includes a computer-readable medium including programmed instructions, the instructions causing a computer to execute: dividing shape data of a surface of an inspection object into a plurality of curved surfaces; calculating a plurality of teaching points indicating positions at which the inspection object is inspected by an inspection device mounted on a movable body; calculating a path between curved surfaces transitioning the plurality of curved surfaces and a path in a curved surface transitioning teaching points within the curved surface of each of the plurality of curved surfaces; and calculating, based on the path between the curved surfaces, the path in the curved surface, and movement performance of the movable body, an orbit of the movable body so that an inspection time of the inspection object becomes shorter.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A processing device comprising:
a memory; and
one or more processors coupled to the memory and configured to:
divide shape data of a surface of an inspection object into a plurality of curved surfaces;
calculate a plurality of teaching points indicating positions at which the inspection object is inspected by an inspection device mounted on a movable body;
calculate a path between curved surfaces transitioning the plurality of curved surfaces and a path in a curved surface transitioning teaching points within the curved surface of each of the plurality of curved surfaces; and
calculate, based on the path between the curved surfaces, the path in the curved surface, and movement performance of the movable body, an orbit of the movable body so that an inspection time of the inspection object becomes shorter.

2. The device according to claim 1, wherein
the movement performance of the movable body includes at least one of a horizontal movement speed of the curved surface, a vertical movement speed of the curved surface, a parallel movement speed of the curved surface, and a curve movement speed of the curved surface, and
the inspection time includes an orbit calculation time until the orbit of the movable body is calculated and an operating time of the movable body when the inspection object is inspected.

3. The device according to claim 1, wherein the one or more processors are configured to divide the shape data of the surface of the inspection object into areas in which a range of a curvature of the surface shape is not more than a threshold to divide the shape data into the plurality of curved surfaces.

4. The device according to claim 1, wherein
the one or more processors are configured to:
perform polygonal division on the shape data of the surface of the inspection object; and
divide the shape data of the surface of the inspection object into a set of polygons in which an angle between normal vectors of adjacent polygons is not more than a threshold to divide the shape data into the plurality of curved surfaces.

5. The device according to claim 1, wherein the one or more processors are configured to calculate, based on the orbit of the movable body, control information controlling at least one of a position and a posture of the inspection device mounted on the movable body.

6. An inspection system comprising:
an inspection device configured to inspect an inspection object;
a movable body configured to control at least one of a position and a posture of the inspection device; and
a processing device,
the processing device comprising:
a memory; and
one or more processors coupled to the memory and configured to:
divide shape data of a surface of the inspection object into a plurality of curved surfaces;
calculate a plurality of teaching points indicating positions at which the inspection object is inspected by the inspection device;
calculate a path between curved surfaces transitioning the plurality of curved surfaces and a path in a curved surface transitioning teaching points within the curved surface of each of the plurality of curved surfaces; and
calculate, based on the path between the curved surfaces, the path in the curved surface, and movement performance of the movable body, an orbit of the movable body so that an inspection time of the inspection object becomes shorter.

7. The system according to claim 6, wherein
the inspection device includes:
an imaging optical system;
an imaging element configured to form an imaging surface of the imaging optical system, the imaging element being configured to capture light incident through the imaging optical system; and
a color filter that includes a wavelength selection area transmitting light within a predetermined wavelength range and is arranged on an optical path of the light to be incident on the imaging element through the imaging optical system, the color filter causing the light within the predetermined wavelength range transmitted through the wavelength selection area to be incident on the imaging element.

8. The system according to claim 6, wherein
the one or more processors are configured to calculate, based on the orbit of the movable body, control information controlling at least one of the position and the posture of the inspection device, and
the movable body controls, based on the control information, at least one of the position and the posture of the inspection device to inspect the inspection object.

9. The system according to claim 8, wherein
the inspection object includes a plurality of inspection objects,
the one or more processors are configured to accept shape data of the plurality of inspection objects in order and process the shape data of the plurality of inspection objects in order to calculate control information of the movable body, and
the movable body controls, based on the control information, at least one of the position and the posture of the inspection device to inspect the plurality of inspection objects in order.

10. The system according to claim 6, wherein
the inspection device includes a plurality of inspection devices and the movable body includes a plurality of movable bodies,
the one or more processors are configured to assign inspections of one or more curved surfaces included in the plurality of curved surfaces to the respective inspection devices, and
the inspection devices respectively inspect the one or more curved surfaces assigned by the one or more processors to inspect the inspection object.

11. The system according to claim 6, further comprising a shaft mechanism configured to move a position of the movable body on an axis, wherein
the one or more processors are configured to assign, when a movement speed on the axis by the shaft mechanism is slower than a movement speed of the movable body, inspections of one or more curved surfaces included in the plurality of curved surfaces to one or more inspection positions on the axis to calculate the orbit of the movable body so that at least one of a number of movements and a movement distance on the axis becomes smaller.

12. A processing method comprising:
dividing, by a processing device, shape data of a surface of an inspection object into a plurality of curved surfaces;
calculating, by the processing device, a plurality of teaching points indicating positions at which the inspection object is inspected by an inspection device mounted on a movable body;
calculating, by the processing device, a path between curved surfaces transitioning the plurality of curved surfaces and a path in a curved surface transitioning teaching points within the curved surface of each of the plurality of curved surfaces; and
calculating, by the processing device, based on the path between the curved surfaces, the path in the curved surface, and movement performance of the movable body, an orbit of the movable body so that an inspection time of the inspection object becomes shorter.

13. A computer program product comprising a non-transitory computer-readable medium including programmed instructions, the instructions causing a computer to execute:
dividing shape data of a surface of an inspection object into a plurality of curved surfaces;
calculating a plurality of teaching points indicating positions at which the inspection object is inspected by an inspection device mounted on a movable body;
calculating a path between curved surfaces transitioning the plurality of curved surfaces and a path in a curved surface transitioning teaching points within the curved surface of each of the plurality of curved surfaces; and
calculating, based on the path between the curved surfaces, the path in the curved surface, and movement performance of the movable body, an orbit of the movable body so that an inspection time of the inspection object becomes shorter.
